(19) United States
(12) Patent Application Publication
(10) Pub. No.: US 2006/0157474 A1
(43) Pub. Date: Jul. 20, 2006

(54) Reliable ceramic heater and manufacturing method thereof

(75) Inventors: Toshikazu Hirose, Anjo-shi (JP); Shoichiro Emmei, Nagoya (JP)

Correspondence Address: NIXON & VANDERHYE, PC, 901 NORTH GLEBE ROAD, 11TH FLOOR, ARLINGTON, VA, 22203, US

(73) Assignee: Denso Corporation, Kariya-city (JP)

(21) Appl. No.: 11/331,339

(22) Filed: Jan. 13, 2006

(30) Foreign Application Priority Data
Jan. 14, 2005 (JP) 2005-007457
Oct. 31, 2005 (JP) 2005-315883

(51) Int. Cl. H05B 3/16

(52) U.S. Cl. 219/543

(57) ABSTRACT

This invention provides a method of manufacturing a ceramic heater which includes the steps of: preparing a ceramic heater base member; applying a platinum paste to a surface of the heater base member so as to form a heater pattern on the surface; applying a ceramic paste to the surface of the heater base member so as to form an insulating layer that covers the heater pattern on the surface; and firing the heater base member with the heater pattern and the insulating layer formed thereon, wherein in the firing step, differences among maximum shrinkage percentages of the heater base member, the heater pattern, and the insulating layer are less than or equal to 5%. With the method, interfacial separation is prevented from occurring at the interfaces among the heater base member, heater pattern, and insulating layer, thus resulting in the ceramic heater having superior insulation properties and durability.

### CROSS-REFERENCE TO RELATED APPLICATION

This application is based on and claims priority from Japanese Patent Applications No. 2005-7457, filed on Jan. 14, 2005, and No. 2005-315883, filed on Oct. 31, 2005, the contents of which are hereby incorporated by reference into this application.

### BACKGROUND OF THE INVENTION

1 Technical Field of the Invention

The present invention relates generally to ceramic heaters and gas sensors. More particularly, the invention relates to a reliable ceramic heater designed to be used in a gas sensor and a manufacturing method thereof, and a gas sensor including such a reliable ceramic heater and a manufacturing method thereof.

2 Description of the Related Art

Gas sensors for sensing the concentration of a specific gas, such as O₂, NOₓ, and CO, in exhaust gases from an automobile generally include a ceramic heater to heat a gas sensing element of the gas sensor.

FIG. 9 shows an example of such a ceramic heater. As shown in the figure, a conventional ceramic heater 9 includes a ceramic heater base member 92, a platinum heater pattern 93 formed on a surface of the heater base member 92, and a ceramic insulating layer 94 formed on the surface of the heater base member 92 to cover the heater pattern 93 on the surface. (With regard to such a ceramic heater, a reference can be made to Japanese Patent First Publication No. H09-180867.)

In manufacture of the ceramic heater 9, the heater base member 92 is first prepared. Then, a platinum paste is applied to the surface of the heater base member 92 so as to form the heater pattern 93. After that, a ceramic paste is further applied to the surface of the heater base member 92 so as to form the insulating layer 94. Finally, the heater base member 92 is fired along with the heater pattern 93 and the insulating layer 94 formed thereon, thereby obtaining the ceramic heater 9.

However, in the above firing step, interfacial separation or interfacial peeling may occur at the interfaces among the heater base member 92, the heater pattern 93, and the insulating layer 94. The cause of such interfacial separation is supposed to be that there exist differences among shrinkage percentages of the heater base member 92, heater pattern 93, and insulating layer 94. Here, the shrinkage percentages of the three members are parameters to represent the degrees of shrinkage of the respective members in the firing step.

In particular, the shrinkage percentage of the heater pattern 93 is smaller than that of the heater base member 92, so that a large stress may be induced at the interface between the heater base member 92 and the heater pattern 93.

Specifically, with reference to FIG. 10A, the platinum paste 930 for forming the heater pattern 93 is made of a mixture of platinum particles 931, alumina particles 932, a binder 933, and dispersant particles 934. The dispersant particles 934 are included to suppress, as illustrated in FIG. 10B, necking (i.e., particle growth) of the platinum particles 931 in the firing step so as to make the resultant heater pattern 93 homogeneous. However, the dispersant particles 934 vaporize in the firing step, thus causing the platinum paste 930 to expand once, as shown in FIG. 10C. Consequently, as shown in FIG. 10D, the resultant heater pattern 93 could not shrink sufficiently in the firing step, thus causing the shrinkage percentage thereof to be small (Further reference can be made to the curve LO in FIG. 2.)

Moreover, to meet the requirement of minimizing gas sensors, ceramic heaters for use in gas sensors are accordingly required to be minimized. However, in a minimized ceramic heater, occurrence of such interfacial separation as described above causes insulation failure and/or corrosion of the heart pattern 93 more easily.

### SUMMARY OF THE INVENTION

It is, therefore, an object of the present invention to overcome the above-mentioned problems accompanying conventional ceramic heaters and gas sensors.

It is another object of the present invention to provide a reliable ceramic heater without interfacial separation occurred therein and a manufacturing method thereof.

It is a further object of the present invention to provide a gas sensor that includes such a reliable ceramic heater and a manufacturing method of the gas sensor.

According to the first aspect of the present invention, a method of manufacturing a ceramic heater is provided which includes the steps of: preparing a ceramic heater base member; applying a platinum paste to a surface of the heater base member so as to form a heater pattern on the surface; applying a ceramic paste to the surface of the heater base member so as to form an insulating layer that covers the heater pattern on the surface; and firing the heater base member with the heater pattern and the insulating layer formed thereon, wherein in the firing step, differences among maximum shrinkage percentages of the heater base member, the heater pattern, and the insulating layer are less than or equal to 5%.

It is preferable that, in the firing step, the differences among the maximum shrinkage percentages of the heater base member, the heater pattern, and the insulating layer are less than or equal to 3.5%.

Further, the ceramic heater is preferably designed to be built in a gas sensor to heat a gas sensing element of the gas sensor which works to sense a concentration of a gas in an atmosphere.

According to the second aspect of the present invention, a ceramic heater is provided which is manufactured by the method of the first aspect of the invention.

According to the third aspect of the present invention, a method of manufacturing a ceramic heater is provided which includes the steps of: preparing a ceramic heater base member; applying a platinum paste to a surface of the heater base member so as to form a heater pattern on the surface; applying a ceramic paste to the surface of the heater base member so as to form an insulating layer that covers the heater pattern on the surface; and firing the heater base member with the heater pattern and the insulating layer formed thereon, wherein the platinum paste is made of a mixture of platinum particles, ceramic particles, and a binder, and wherein the platinum particles each have a surface coated with a ceramic.

It is preferable that the surfaces of the platinum particles are each coated with alumina.

Further, the ceramic heater is preferably designed to be built in a gas sensor to heat a gas sensing element of the gas sensor which works to sense a concentration of a gas in an atmosphere.

According to the fourth aspect of the present invention, a ceramic heater is provided which is manufactured by the method of the third aspect of the invention.

According to the fifth aspect of the present invention, a method of manufacturing a gas sensor, which includes a gas sensing element working to sense a concentration of a gas in an atmosphere and a ceramic heater working to heat the gas sensing element, is provided which includes the steps of: preparing a ceramic heater base member; applying a platinum paste to a surface of the heater base member so as to form a heater pattern on the surface; applying a ceramic paste to the surface of the heater base member so as to form an insulating layer that covers the heater pattern on the surface; and firing the heater base member with the heater pattern and the insulating layer formed thereon, wherein in the firing step, differences among maximum shrinkage percentages of the heater base member, the heater pattern, and the insulating layer are less than or equal to 5%.

It is preferable that in the firing step, the differences among the maximum shrinkage percentages of the heater base member, the heater pattern, and the insulating layer are less than or equal to 3.5%.

According to the sixth aspect of the present invention, a gas sensor is provided which is manufactured by the method of the fifth aspect of the invention.

According to the seventh aspect of the present invention, a method of manufacturing a gas sensor, which includes a gas sensing element working to sense a concentration of a gas in an atmosphere and a ceramic heater working to heat the gas sensing element, is provided which includes the steps of: preparing a ceramic heater base member; applying a platinum paste to a surface of the heater base member so as to form a heater pattern on the surface; applying a ceramic paste to the surface of the heater base member so as to form an insulating layer that covers the heater pattern on the surface; and firing the heater base member with the heater pattern and the insulating layer formed thereon, wherein the platinum paste is made of a mixture of platinum particles, ceramic particles, and a binder, and wherein the platinum particles each have a surface coated with a ceramic.

It is preferable that the surfaces of the platinum particles are each coated with alumina.

According to the eighth aspect of the present invention, a gas sensor is provided which is manufactured by the method of the seventh aspect of the invention.

Consequently, through providing the above ceramic heaters and gas sensors and the manufacturing methods thereof, the objects of the present invention are achieved.

### BRIEF DESCRIPTION OF THE DRAWINGS

The present invention will be understood more fully from the detailed description given hereinafter and from the accompanying drawings of the preferred embodiment of the invention, which, however, should not be taken to limit the invention to the specific embodiment but are for the purpose of explanation and understanding only.

In the accompanying drawings:

FIG. 1 is a cross-sectional view showing the overall structure of a ceramic heater according to an embodiment of the invention;

FIG. 2 is a graphical representation showing the change of shrinkage percentage with temperature for each of the members of the ceramic heater of FIG. 1;

FIG. 3A is a pattern diagram showing a platinum paste for forming a heater pattern of the ceramic heater of FIG. 1;

FIG. 3B is a pattern diagram showing the heater pattern, formed with the platinum paste of FIG. 3A, of the ceramic heater of FIG. 1;

FIGS. 4A-4D are schematic views illustrating agglutination of ceramic coating layers formed on platinum particles included in the platinum paste of FIG. 3A during firing;

FIGS. 5A-5C are pattern diagrams illustrating formation of the ceramic coating layers on the respective platinum particles in the platinum paste of FIG. 3A;

FIG. 6 is a graphical representation showing the relationship between the upper limit for the differences among the maximum shrinkage percentages of members of a ceramic heater and the occurrence rate of interfacial separation in that ceramic heater;

FIG. 7 is a cross-sectional view showing the overall structure of a gas sensing element that is integrally laminated with the ceramic heater of FIG. 1;

FIG. 8 is a partially cross-sectional view showing the overall structure of a gas sensor that includes the gas sensing element of FIG. 7;

FIG. 9 is a cross-sectional view showing the overall structure of a conventional ceramic heater; and

FIGS. 10A-10D are pattern diagrams illustrating formation of a heater pattern of the conventional ceramic heater of FIG. 9 from a conventional platinum paste.

### DESCRIPTION OF THE PREFERRED EMBODIMENT

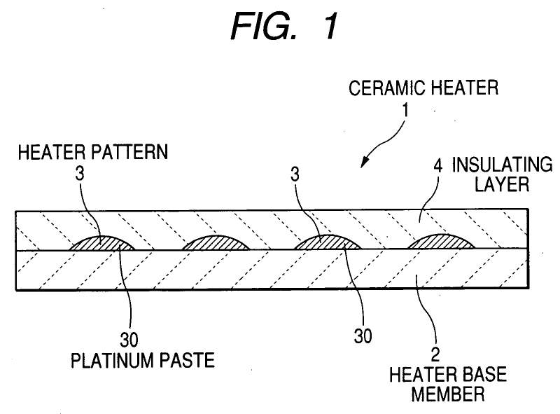

The preferred embodiment of the present invention will be described hereinafter with reference to FIGS. 1-8.

It should be noted that, for the sake of clarity and understanding, identical components having identical functions have been marked, where possible, with the same reference numerals in each of the figures.

In this embodiment, a ceramic heater 1 is provided which is for use in a gas sensor 6 that is to be descried in detail later. FIG. 1 shows the overall structure of the ceramic heater 1.

As shown in FIG. 1, the ceramic heater 1 includes a ceramic heater base member 2, a platinum heater pattern 3 formed on a surface of the heater base member 2, and a ceramic insulating layer 4 formed on the surface of the heater base member 2 to cover the heater pattern 3 on the surface.

The ceramic heater 1 is manufactured according to the following process. First, the ceramic heater base member 2 is prepared. Then, a platinum paste 30 is applied to the surface of the heater base member 2 so as to form the platinum heater pattern 3. After that, a ceramic paste is further applied to the surface of the heater base member 2 so as to form the ceramic insulating layer 4. Finally, the heater base member 2 is fired along with the heater pattern 3 and the insulating layer 4 formed thereon, thereby obtaining the ceramic heater 1.

In the firing step of the above manufacturing process, differences among maximum shrinkage percentages of the heater base member 2, the heater pattern 3, and the insulating layer 4 are specified to be less than or equal to 5%.

A shrinkage percentage of a member of the ceramic heater 1 represents the ratio of the volume loss of the member at a time instant in the firing step (i.e., the difference between the original volume of the member prior to the firing step and the volume of the member at that time instant) to the original volume of the member prior to the firing step. Accordingly, the maximum shrinkage percentage of the member represents the ratio of the maximum volume loss of the member during the whole firing step to the original volume of the member prior to the firing step. Generally, the maximum shrinkage percentage of the member approximately coincides with a shrinkage percentage of the member at the highest temperature during the firing step or a shrinkage percentage of the member after the firing step.

Specifically, in the firing step, the temperature of the heater base member 2, the heater pattern 3 (i.e., the platinum paste 30), and the insulating layer 4 (i.e., the ceramic paste) is gradually increased from room temperature to about 145° C.

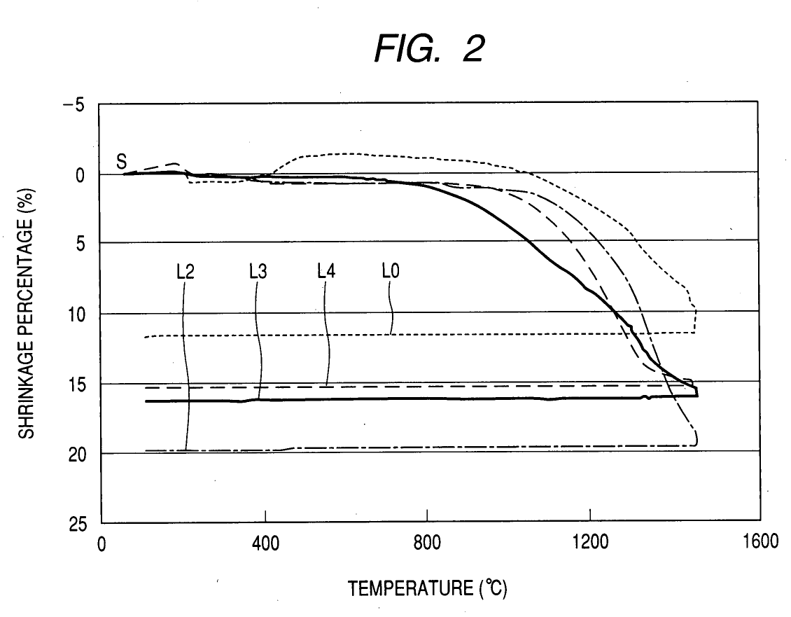

During this process, the heater base member 2, the heater pattern 3, and the insulating layer 4 may shrink as shown in FIG. 2, in which curves L2, L3, and L4 respectively indicate the changes of shrinkage percentage of the heater base member 2, heater pattern 3, and insulating layer 4 with temperature and S indicates the start of the firing process.

It can be seen from FIG. 2 that the maximum shrinkage percentages of the heater base member 2, heater pattern 3, and insulating layer 4 in the firing step are about 19.5%, about 16.5%, and about 15%, respectively. Accordingly, the differences among the maximum shrinkage percentages of the heater base member 2, heater pattern 3, and insulating layer 4 in the firing step become less than or equal to 5%.

Through specifying the above range of the differences, it becomes possible to prevent a large stress from being induced at the interfaces between the heater base member 2 and the heater pattern 3, between the heater base member 2 and the insulating layer 4, and between the heater pattern 3 and the insulating layer 4. Consequently, interfacial separation or interfacial peeling is prevented from occurring at those interfaces, thus resulting in the ceramic heater 1 having superior insulation properties and durability.

To more reliably prevent occurrence of interfacial separation at the interfaces, it is preferable to further specify the differences among the maximum shrinkage percentages of the heater base member 2, the heater pattern 3, and the insulating layer 4 in the firing step to be less than or equal to 3.5%.

In the present embodiment, the heater base member 2 is composed of alumina (Al₂O₃), and the ceramic paste for forming the insulating layer 4 is an alumina paste.

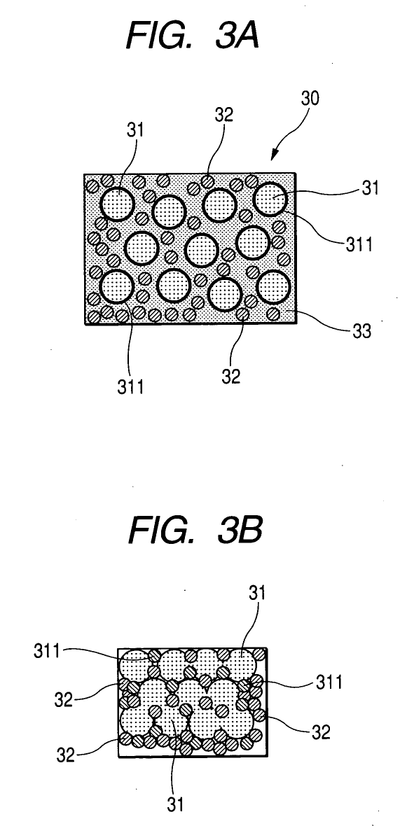

The platinum paste 30 for forming the heater pattern 3 is, as shown in FIG. 3A, made of a mixture of platinum particles 31, ceramic particles 32, and a binder 33. Each of the platinum particles 31 has a surface on which a ceramic coating layer 311 is formed.

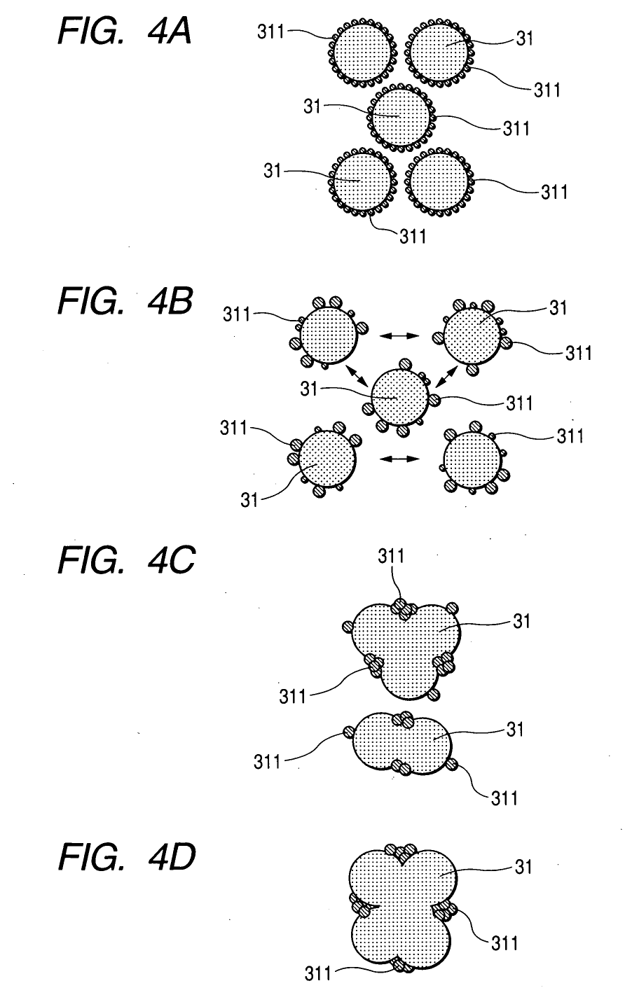

More microscopically, the ceramic coating layers 311 are, as shown in FIG. 4A, supported on the surfaces of the respective platinum particles 31 in the form of minute ceramic particles. The ceramic coating layers 311 each have a thickness, for example, of about 0.6 μm.

Referring now to FIG. 3B, the binder 33 in the platinum paste 30 vaporizes in the firing step, so that the ceramic particles forming the ceramic coating layers 311 and the ceramic particles 32 agglutinate.

More specifically, as shown in FIG. 4B, when the firing temperature has increased, for example, to about 800° C., the ceramic particles forming the ceramic coating layers 311 start to agglutinate on the surfaces of the respective platinum particles 31.

Further, as shown in FIG. 4C, when the firing temperature has increased, for example, to 1000° C., the agglutination of the ceramic particles forming the ceramic layers 311 advances to expose the surfaces of the respective platinum particles 31, so that the platinum particles 31 start necking.

Furthermore, as shown in FIG. 4D, when the firing temperature has increased, for example, to 1500° C., the necking of the platinum particles 31 further advances.

Consequently, after the firing step, the resultant heater pattern 3 of the ceramic heater 1 is composed of the platinum particles 31, each of which has the surface partially covered with the ceramic coating layer 311, and the ceramic particles 32 that are interposed among the platinum particles 31.

The platinum particles 31 included in the platinum paste 30 are prepared in the following way.

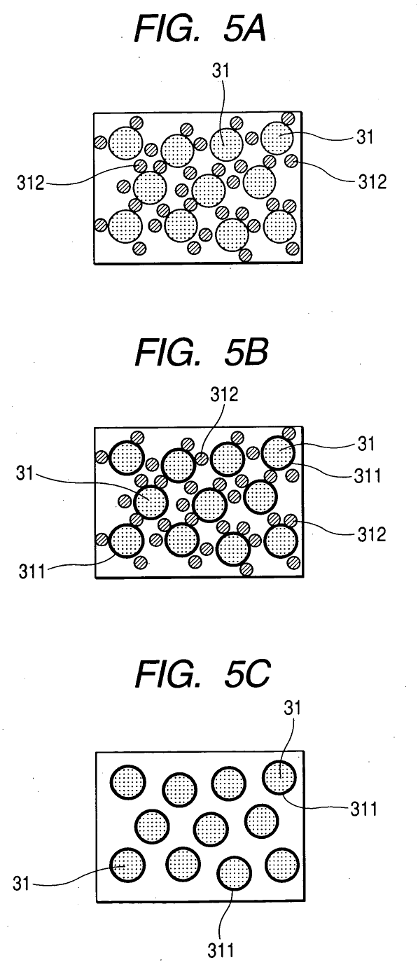

First, as shown in FIG. 5A, a platinum powder consisting of platinum particles 31, an alumina compound (not shown in the figure), and dispersant particles 312 are mixed in water to cause a chemical reaction therebetween.

Since the dispersant particles 312 are included in the mixture, the platinum particles 31 are prevented from necking, so that the ceramic coating layers 311 are formed on the respective platinum particles 31, as shown in FIG. 5B.

Then, the mixture is heat-treated to remove the dispersant particles 312, so that a platinum powder, which consists of the ceramic-coated platinum particles 31, are obtained, as shown in FIG. 5C. The obtained platinum powder is then used to make the platinum paste 30 as described above.

It should be noted that, in the above mixture, the amount of alumina is, preferably, in the range of 500 to 5000 ppm. If the amount of alumina is less than 500 ppm, it may be difficult to prevent necking (i.e., particle growth) of the platinum particles 31 in the firing step of manufacture of the ceramic heater 1. On the contrary, if the amount of alumina is greater than 5000 ppm, the electrical conductivity of the resultant heater pattern 3 of the ceramic heater 1 may be too low.

As described above, in the present embodiment, the platinum paste 30 for forming the heater pattern 3 includes the platinum particles 31 each having the surface covered with the ceramic coating layer 311.

Consequently, it becomes possible to prevent necking of the platinum particles 31 from occurring at early stage of the firing step (i.e., at relatively low firing temperature), without adding any dispersant particles in the platinum paste 30.

Further, since no dispersant particles are included in the platinum paste 30 to cause the heater pattern 3 (i.e., the platinum paste 30) to expand once in the firing step, the shrinkage percentage of the heater pattern 3 is, as indicated by the curve L3 in FIG. 2, prevented from becoming low in the firing step.

Consequently, it becomes possible to make small the differences among the maximum shrinkage percentages of the heater base member 2, the heater pattern 3, and the insulating layer 4, thereby preventing occurrence of interfacial separation at the interfaces among those members.

In comparison, as described previously, the platinum paste 930 for forming the heater pattern 93 of the conventional ceramic heater 9 includes the platinum particles 931, each of which has the surface not covered with any ceramic coating layer, and the dispersant particles 934.

Consequently, as indicated by the curve LO in FIG. 2, when the firing temperature has increased to 400 to 500° C., the shrinkage percentage of the heater pattern 93 (i.e., the platinum paste 930) becomes minus, in other words, the heater pattern 93 starts to expand. This expansion may be caused by the vaporization of the dispersant particles 934 included in the heater pattern 93. With further increase of the firing temperature, the shrinkage percentage of the heater pattern 93 returns to plus, but cannot become large enough to approach the shrinkage percentage of the heater base member 92.

An experimental investigation has been conducted to determine the effect of the differences among the maximum shrinkage percentages of the heater base member 2, heater pattern 3, and insulating layer 4 on the occurrence rate of interfacial separation in the ceramic heater 1.

Three different ceramic heater types A, B, and C were used in the investigation, and ten sample ceramic heaters were fabricated for each of the three types.

Specifically, each of the A type sample heaters was fabricated according to the present invention such that the differences among the maximum shrinkage percentages of the three members (i.e., the heater base member, the heater pattern, and the insulating layer) in the firing step were not greater than 3.3%.

Each of the B type sample heaters was also fabricated according to the present invention. However, in the fabrication of the B type sample heaters, the platinum particles 31 had a smaller diameter and the heat treatment after the ceramic coating was conducted at a higher temperature than in the fabrication of the A type sample heaters. Consequently, in the case of the B type sample heaters, the differences among the maximum shrinkage percentages of the three members became not greater than 4.7%.

In comparison, each of the C type sample heaters was fabricated according to the conventional method such that the differences among the maximum shrinkage percentages of the three members were not greater than 6.7%.

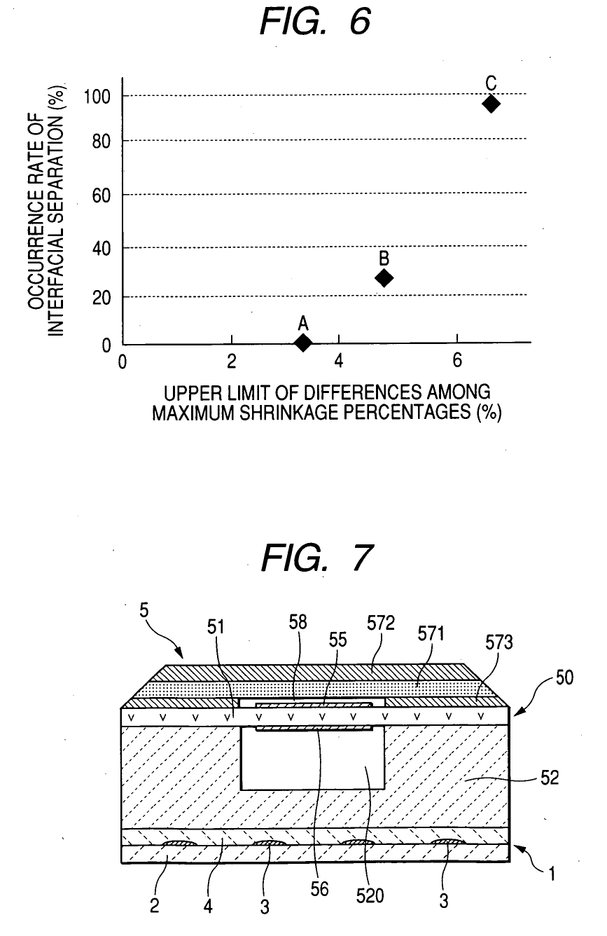

FIG. 6 shows the investigation results, in which the horizontal axis represents the upper limit of the differences among the maximum shrinkage percentages of the three members, while the vertical one represents the resultant occurrence rate of interfacial separation.

It can be seen from FIG. 6 that the occurrence rate of interfacial separation for the heater type C was almost 100%, while those for the heater types A and B were significantly decreased. In other words, occurrence of interfacial separation can be suppressed by specifying the differences among the maximum shrinkage percentages of the three members to be not greater than 5%.

It can further be seen from FIG. 6 that the occurrence rate of interfacial separation for the heater type A was 0%. In other words, occurrence of interfacial separation can be completely suppressed by specifying the differences among the maximum shrinkage percentages of the three members to be not greater than 3.5%.

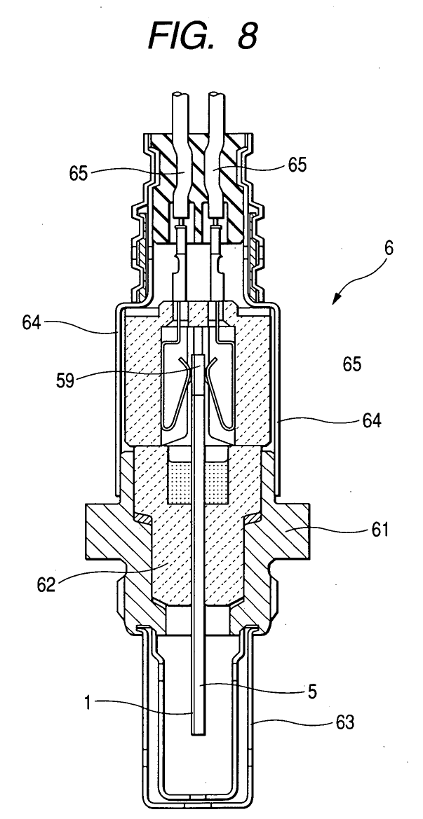

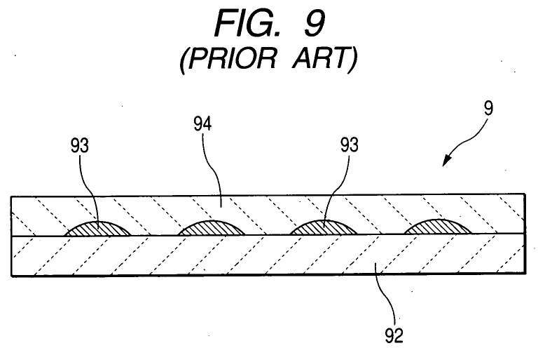

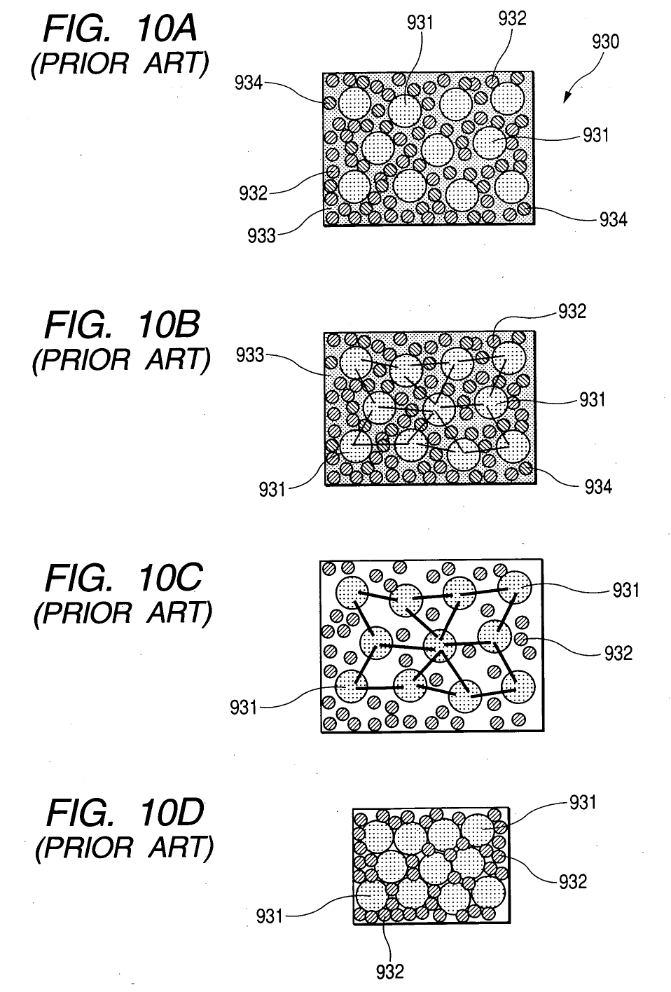

Having described the ceramic heater 1, the gas sensor 6 that includes such a ceramic heater 1 will be described hereinafter with reference to FIGS. 7 and 8.

The gas sensor 6 may be used in an air/fuel ratio control system of an automobile to sense the concentration of O₂ in exhaust gases from the automobile. The gas sensor 6 may also be used in a device for detecting degradation of an automotive three-way catalyst to sense the concentration of NOₓ in exhaust gases from the automobile. In addition, the gas sensor 6 may also be used, in any other cases, to sense the concentration of a specific gas in an atmosphere.

In this embodiment, the gas sensor 6 includes a laminate type gas sensing element 5 that is integrally laminated with the ceramic heater 1.

Specifically, as shown in FIG. 7, the gas sensing element 5 includes a sensor cell 50 that is configured with a solid electrolyte panel 51, a measured gas side electrode 55, and a reference gas side electrode 56. The measured gas side electrode 55 is provided on a major surface of the solid electrolyte panel 51 and to be exposed to a measured gas. The reference gas side electrode 56 is provided the other major surface of the solid electrolyte panel 51 and to be exposed to a reference gas.

The solid electrolyte panel 51 is laminated, via a spacer 52 for forming a reference gas chamber 520, on the insulating layer 4 of the ceramic heater 1. Further, on the solid electrolyte panel 51, there are sequentially laminated a porous diffused resistor layer 571 and a shielding layer 572, with a spacer 573 for forming a measured gas chamber 58 interposed between the porous diffused resistor layer 571 and the solid electrolyte panel 51.

Referring to FIG. 8, the gas sensor 6 includes, in addition to the gas sensing element 5 and the ceramic heater 1, a housing 61, an insulator 62, a first cover 63, a second cover 64, and leads 65.

The housing 61 retains therein the insulator 62 that partially surrounds the gas sensing element 5 and the ceramic heater 1. The first cover 63 is fixed to a tip end of the housing 61 to protect the gas sensing element 5. The second cover 64 is fixed to a base end of the housing 61 opposite to the tip end. The leads 61 are provided in a base end portion of the gas sensor 6 and electrically connected to electrodes that are provided at a base end 59 of the gas sensing element 5.

Since the gas sensor 6 includes the ceramic heater 1 that has superior insulation properties and durability as descried above, the gas sensing element 5 of the gas sensor 6 can be reliably heated by the ceramic heater 1, thus ensuring high performance of the gas sensor 6.

While the above particular embodiment of the invention has been shown and described, it will be understood by those who practice the invention and those skilled in the art that various modifications, changes, and improvements may be made to the invention without departing from the spirit of the disclosed concept.

For example, in the previous embodiment, the ceramic heater 1 is integrally laminated with the laminate type gas sensing element 5.

However, the ceramic heater 1 may also be provided in a cup-shaped gas sensing element, with the shape thereof being accordingly cylindrical.

Such modifications, changes, and improvements within the skill of the art are intended to be covered by the appended claims.

What is claimed is:

1. A method of manufacturing a ceramic heater comprising the steps of:
preparing a ceramic heater base member;
applying a platinum paste to a surface of said heater base member so as to form a heater pattern on the surface;
applying a ceramic paste to the surface of said heater base member so as to form an insulating layer that covers said heater pattern on the surface; and
firing said heater base member with said heater pattern and said insulating layer formed thereon,
wherein in the firing step, differences among maximum shrinkage percentages of said heater base member, said heater pattern, and said insulating layer are less than or equal to 5%.

2. The method as set forth in claim 1, wherein in the firing step, the differences among the maximum shrinkage percentages of said heater base member, said heater pattern, and said insulating layer are less than or equal to 3.5%.

3. The method as set forth in claim 1, wherein the ceramic heater is designed to be built in a gas sensor to heat a gas sensing element of the gas sensor which works to sense a concentration of a gas in an atmosphere.

4. A ceramic heater manufactured by the method of claim 1.

5. A method of manufacturing a ceramic heater comprising the steps of:
preparing a ceramic heater base member;
applying a platinum paste to a surface of said heater base member so as to form a heater pattern on the surface;
applying a ceramic paste to the surface of said heater base member so as to form an insulating layer that covers said heater pattern on the surface; and
firing said heater base member with said heater pattern and said insulating layer formed thereon,
wherein the platinum paste is made of a mixture of platinum particles, ceramic particles, and a binder, and wherein the platinum particles each have a surface coated with a ceramic.

6. The method as set forth in claim 5, wherein the surfaces of the platinum particles are each coated with alumina.

7. The method as set forth in claim 5, wherein the ceramic heater is designed to be built in a gas sensor to heat a gas sensing element of the gas sensor which works to sense a concentration of a gas in an atmosphere.

8. A ceramic heater manufactured by the method of claim 5.

9. A method of manufacturing a gas sensor, which includes a gas sensing element working to sense a concentration of a gas in an atmosphere and a ceramic heater working to heat the gas sensing element, comprising the steps of:
preparing a ceramic heater base member;
applying a platinum paste to a surface of said heater base member so as to form a heater pattern on the surface;
applying a ceramic paste to the surface of said heater base member so as to form an insulating layer that covers said heater pattern on the surface; and
firing said heater base member with said heater pattern and said insulating layer formed thereon,
wherein in the firing step, differences among maximum shrinkage percentages of said heater base member, said heater pattern, and said insulating layer are less than or equal to 5%.

10. The method as set forth in claim 9, wherein in the firing step, the differences among the maximum shrinkage percentages of said heater base member, said heater pattern, and said insulating layer are less than or equal to 3.5%.

11. A gas sensor manufactured by the method of claim 9.

12. A method of manufacturing a gas sensor, which includes a gas sensing element working to sense a concentration of a gas in an atmosphere and a ceramic heater working to heat the gas sensing element, comprising the steps of:
preparing a ceramic heater base member;
applying a platinum paste to a surface of said heater base member so as to form a heater pattern on the surface;
applying a ceramic paste to the surface of said heater base member so as to form an insulating layer that covers said heater pattern on the surface; and
firing said heater base member with said heater pattern and said insulating layer formed thereon,
wherein the platinum paste is made of a mixture of platinum particles, ceramic particles, and a binder, and wherein the platinum particles each have a surface coated with a ceramic.

13. The method as set forth in claim 12, wherein the surfaces of the platinum particles are each coated with alumina.

14. A gas sensor manufactured by the method of claim 12.
